(19) United States
(12) Patent Application Publication
(10) Pub. No.: US 2013/0026665 A1
(43) Pub. Date: Jan. 31, 2013

(54) FLUID MIXING APPARATUS

(71) Applicants: Augusto Buosi, Porcia (IT); Matteo Simioni, Porcia (IT)

(72) Inventors: Augusto Buosi, Porcia (IT); Matteo Simioni, Porcia (IT)

(73) Assignee: ELECTROLUX HOME PRODUCTS CORPORATION N.V., Brussel (BE)

(21) Appl. No.: 13/639,276

(22) PCT Filed: Apr. 8, 2011
(86) PCT No.: PCT/EP2011/055548

§ 371 Date: Oct. 4, 2012

(30) Foreign Application Priority Data
Apr. 9, 2010 (IT) MI2010A000597

(51) Int. Cl. F25D 23/12; A23L 2/54; B01F 3/04

(52) U.S. Cl. 261/64.3

(57) ABSTRACT

A refrigerator is proposed comprising a fluid mixing apparatus (100) for adding a gas, contained in a storage bottle (125) provided with a valve device (130), to a liquid within a mixing chamber (105); the mixing between the gas and the liquid within the mixing chamber forms a composite solution of mixed gas and liquid and gas being not mixed with the liquid. The pressure value of said non-mixed gas is indicative of the amount of mixed gas within the composite solution. The fluid mixing apparatus according to an embodiment of the present invention comprises a pressure detector (199) configured to detect the pressure value of the non-mixed gas within the mixing chamber; and control means (145, 165, 170, 175, 180, 185, 190, 195, 197) for controlling, as a function of the detected pressure value, the opening or closing of said valve device in order to automatically adjust the gas flow from the storage bottle to the mixing chamber.

The present invention generally relates to the field of apparatuses for fluid mixing. More particularly, the present invention relates to devices for adding gas to fluids, for example carbonator devices for obtaining carbonated beverages from non-carbonated beverages.

Carbonated beverages, such as for example sparkling water, thanks to the action of stimulation and anaesthetization on the taste receptors, provide a remarkable thirst quenching and refreshing feeling to the palate, and are therefore particularly appreciated by a significant number of consumers. At the present state, given the scarcity of naturally sparkling water sources (i.e., naturally gassed) with respect to market demand, the sparkling feature of the carbonated water is often obtained artificially thanks to devices called carbonators (of home or industrial type) that implement a process of addition of carbon dioxide (also known as CO2) to the non-carbonated water.

In the state of the art several carbonators devices are known, which are based substantially on the same operating principle implemented by a suitable fluid dynamic system. In such system, carbon dioxide, compressed at high-pressure within a bottle (typically, at a pressure of about 40 bar), is collected within a suitable container (called carbonator). The carbonator is also adapted to receive within it primary water, or water (or, in general, other types of non-carbonated beverages) to be carbonated, and to provide carbonated water resulting from the mixing process between the carbon dioxide and the primary water within the carbonator.

In particular, the mixing process is such that part of the carbon dioxide entered into the carbonator mixes with the primary water thereby forming carbonated water, whereas the remaining part of carbon dioxide remains undissolved within the carbonator. As known, the pressure value of such undissolved carbon dioxide within the carbonator is a parameter indicative of the carbonation level of the obtained carbonated water; in fact, the solution carbon dioxide—water substantially follows the Henry law, according to which, at constant temperature, the amount of gas dissolved in a given liquid volume is proportional to the pressure of gas above the solution.

Typically, a pin valve is screwed to the intake of the bottle, which valve can be activated by a pin actuator, which prevents the outflow of gas from the bottle when the latter is not inserted in the system.

The known water carbonation system includes the use of a mechanical pressure reducer for reducing the high pressure of the carbon dioxide compressed within the bottle down to the desired pressure, at equilibrium, within the carbonator; such pressure, as above highlighted, depends on the carbonation level that is desired to provide to the carbonated water, but typically is around values of about 4 bar (and therefore in the following it will be referred to as low pressure, with respect to the high pressure of the carbon dioxide within the bottle).

Such pressure reducer is typically a two-way device: one way completely screwed on the pin valve of the bottle, for receiving the high-pressure gas, and the other way for providing the low pressure gas to the carbonator. The pin is housed within such device (in order to activate the gas flow from the bottle as soon as the device is screwed to the valve), as well as a mechanical device that performs the actual pressure reduction; such mechanical device typically includes a membrane that, by deforming under the action of a suitable pressure, activates a shutter, thereby pushing it into an opening configuration of the pressure reducer, and a spring connected to the membrane and externally adjustable by a suitable knob.

More specifically, pre-loading the spring through the knob, the membrane causes a thrust on the shutter thereby causing the opening of the pressure reducer, and therefore allowing the carbon dioxide coming from the first way of the pressure reducer to flow into the second way and hence within the carbonator; it should be noted that, by virtue of the pressure difference between the bottle and the carbonator, the gas flow is facilitated and assisted by the known Venturi effect, which substantially ties the pressure and velocity of a fluid current according to an inverse proportionality law.

The increase in pressure within the carbonator up to the desired value (depending on the desired carbonation level, and established by the extent of the loading of the spring), generates a thrust on the membrane itself in contrast to the force exerted by the spring on the membrane. This causes a counter-thrust on the shutter, which, by obstructing the flow of carbon dioxide towards the carbonator, determines the closure of the pressure reducer. Therefore, the pin valve is modulated by the opposing forces acting on the membrane: the gas pressure downstream the pressure reducer (that tends to close it), and the thrust of the spring (that tends to open it).

The use of such carbonation system, however, has such drawbacks that preclude reliability thereof over the time, not only in industrial applications, wherein large amounts of water and/or beverages are handled, but also in household uses. First, the use of the membrane and of the shutter associated therewith involves a clear level of sophistication and complication of the system, as well as delicacy of its components. Moreover, as the (high) pressure of the carbon dioxide within the bottle is fully exerted on the pressure reducer (through the first way), the latter must necessarily be made of undeformable and high-resistance materials (such as metals, or alloys thereof), which are difficult to work whilst maintaining the production costs low.

In addition, the regulation of the carbonation level must be performed manually by acting on the load of the spring through the knob, which means that such regulation has a precision that may not be adequate in many applications, because of the mechanical tolerances and their uncontrollable variations due to different, and unpredictable, wear levels of the components.

Furthermore, such system requires that, at equilibrium, a pressure within the carbonator is not lower than a predetermined value; such pressure must be sufficient to overcome the spring force when the latter is regulated, by the knob, to exert a minimum thrust on the membrane, otherwise in such condition the closure of the pressure reducer (and hence the interruption of gas) would not take place. The need to have a minimum pressure involves a clear limitation in terms of the carbonation levels that can be obtained, and hence in terms of satisfaction of different needs and tastes of the consumers.

In view of the state of the art so far described, it is an object of the present invention to overcome the cited drawbacks.

According to the present invention, a refrigerator is provided comprising a fluid mixing apparatus (for example, a carbonation apparatus) for adding a gas, contained in a storage bottle provided with a valve device, to a liquid within a mixing chamber; the mixing between the gas and the liquid within the mixing chamber forms a composite solution of mixed gas and liquid and gas being not mixed with the liquid, wherein the pressure value of said non-mixed gas is indicative of the amount of mixed gas within the composite solution. The fluid mixing apparatus comprises a pressure detector configured to detect the pressure value of the unmixed gas within the mixing chamber, and control means for controlling, as a function of the detected pressure value, the opening or closing of said valve device in order to automatically adjust the gas flow from the storage bottle to the mixing chamber.

The pressure detector or sensor is operable for transducing the detected pressure value into a corresponding electric signal supplied to said control means, and said control means are operable for processing said electric signal and, depending on the results of the processing, for controlling the valve device to adjust the gas flow from the storage bottle to the mixing chamber.

In particular, the control means may include an activation device of the valve device mountable on said valve device, and an actuation assembly adapted to actuate said activation device on the basis of the electric signal provided by the pressure detector. Such activation device may include, for example, a movable actuator element adapted to exert or release a thrust on a movable member of the valve device so as to allow the opening or closing of the valve device, respectively.

In turn, the actuation assembly may advantageously include a cam actuator device implemented, for example, by a motor-shaft-cam-cam follower assembly, wherein such cam actuator device may be configured for moving the movable actuator element, or a solenoid operatively coupled with the movable actuator element and activatable for moving the same. Advantageously, the actuation assembly may have an automatic control; for example, it may include an electronic controller adapted to receive the electric signal indicative of the pressure of the unmixed gas within the mixing chamber and to provide a corresponding control signal to the motor means for controlling the start or the stop thereof, depending on whether said pressure within the mixing chamber is lower than or equal to a predefined pressure value, respectively.

According to another aspect of the present invention a fluid mixing apparatus is provided whose employment may be useful, in general, in home and/or industrial liquid and/or gas mixing apparatuses.

Thanks to the present invention, it is possible to make a simple and reliable automatic carbonation apparatus, having high precision and extreme ease of setting of the carbonation levels (e.g., by acting on suitable parameters of the controller and/or the pressure sensor). Moreover, since the carbonation apparatus regulates the gas flow coming from the bottle by opening or closing the valve instead of the pressure reducer, the activation device, not having to act as a pressure reducer, is never hit by potentially harmful pressurized gas jets; this allows making the activation device in materials less resistant than metals, but easier, and therefore more economic, to work (such as plastic materials).

The described apparatus also allows loading water to be carbonated within the carbonator at a pressure lower than said predetermined value necessary for the proper functioning of the known pressure reducer, this allowing to have a wide variety of carbonation levels, and thus of types of carbonated waters/beverages that can be obtained.

These and other features and advantages of the solution according to the present invention will be better understood with reference to the following detailed description of possible embodiments thereof, given purely by way of non-limiting example, to be read in conjunction with the attached drawings. In this regard, it is expressly understood that the drawings are not necessarily drawn to scale and that, unless otherwise indication, they are simply intended to conceptually illustrate the described structures and procedures. In particular:

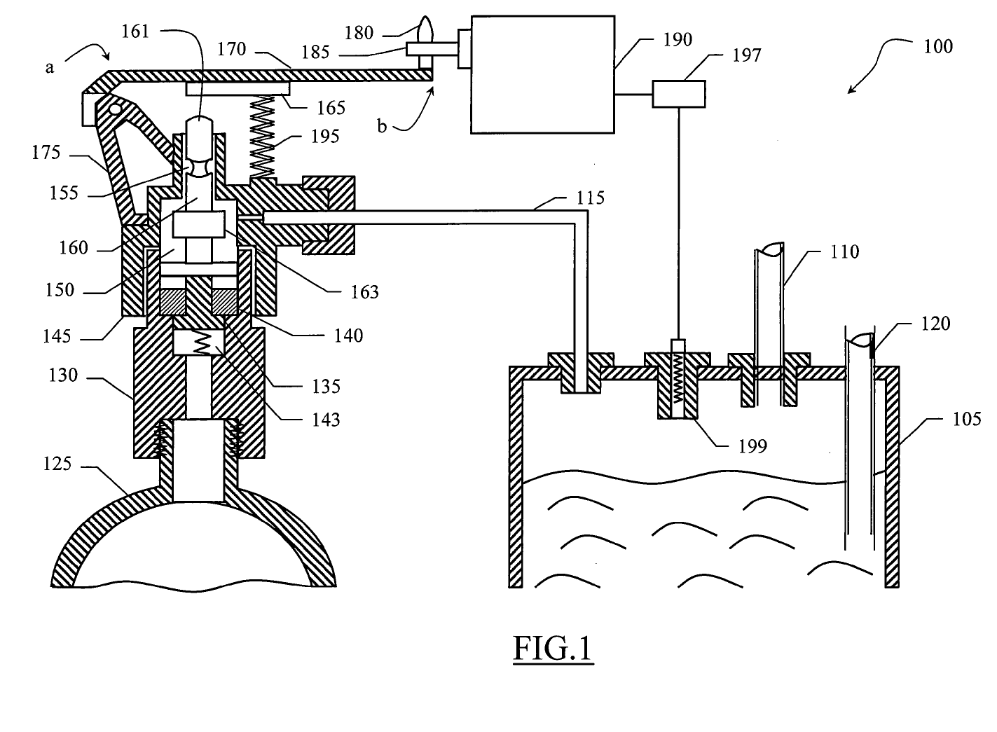

FIG. 1 schematically shows in cross section a fluid mixing apparatus, particularly a beverage carbonating apparatus, according to an embodiment of the present invention, and

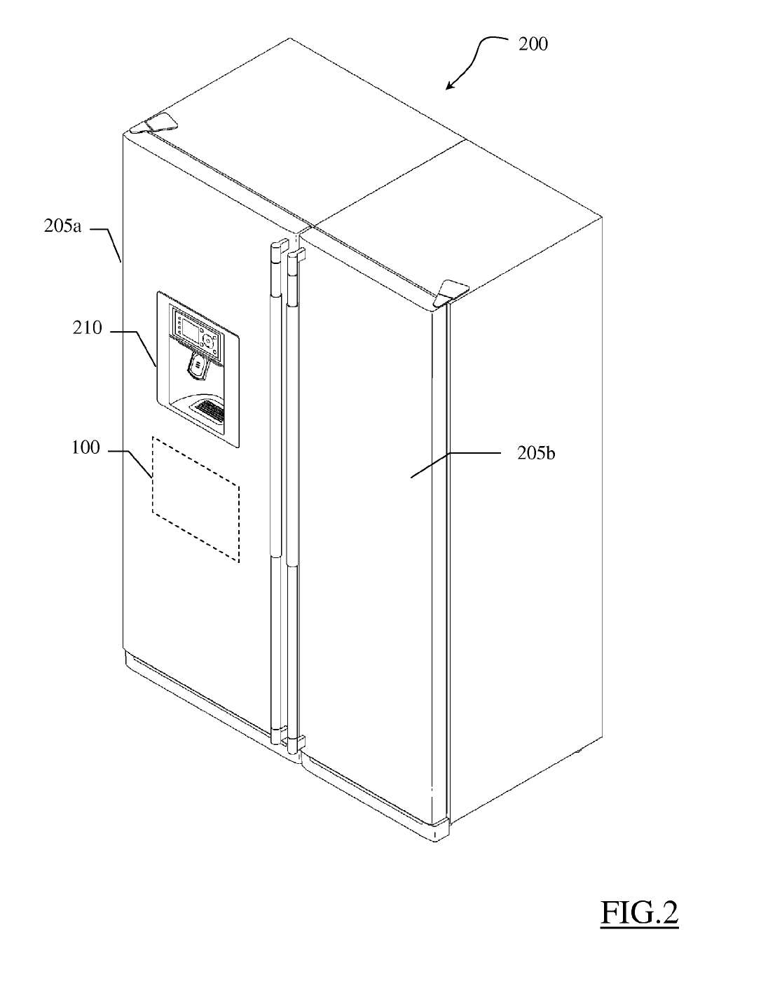

FIG. 2 schematically shows an appliance wherein the apparatus of FIG. 1 may be used.

With reference to the figures, FIG. 1 schematically shows a fluid mixing apparatus, particularly a beverage carbonating apparatus 100; in the described exemplary embodiment, reference will be made to the process of carbonation of water for the sake of convenience, but it is understood that this is not limiting for the present invention, since, as it can be well understood, a generic carbonated beverage is prepared from carbonated water possibly already added with flavours.

The carbonation apparatus 100 includes a container 105, called carbonator, adapted to receive primary water, i.e. water to be carbonated, through an inlet pipe 110, and a solvent gas (carbon dioxide to be mixed with the primary water, in the example herein considered) through a gas supply pipe 115, and to provide the carbonated water, obtained by mixing the carbon dioxide with the primary water, through a corresponding delivery pipe 120.

A bottle 125 is associatable with the carbonating apparatus 100, which bottle is adapted to contain the carbon dioxide to be used in the carbonation process; the carbon dioxide is compressed within the bottle 125 typically at a high pressure (about 40 bar), so as to store relatively large amounts of carbon dioxide and thus allow using the bottle 125 in several carbonation cycles without having to recur to a frequent replacement thereof.

At the inlet of the bottle 125 a pin valve 130 of a known type can be mounted, for example by screwing, which valve includes a movable body 135, sliding within a chamber formed in the valve body 130 and adapted to cooperate with a gasket 140 to inhibit the outflow of gas from the bottle 125; in this way, the passage of carbon dioxide coming from the bottle 125 is allowed through vent grooves (not visible in the figure) in the movable body 135 only when the latter is stressed by an actuator acting as a pin (opening condition of the valve 130), as will be explained in more detail in the following; in the absence of such stress, a spring 143 pushes the movable body 135 against the gasket 140 to prevent the gas outflow.

An activation device 145 is mounted on the valve 130, which activation device includes a hollow chamber 150 connecting the chamber provided within the valve body 130 and the gas supply pipe 115, and a vertical stroke chamber 155, which extends from the hollow chamber 150 up to substantially the top (open) end of the activation device 145.

An actuator 160, vertically movable within the hollow chamber 150 and the stroke chamber 155, is aligned to the movable body 135, and is configured so as to implement substantially two basic operating configurations: in a rest configuration (determining the closure of the valve 130), the actuator 160 simply rests on the movable body 135 without exerting substantially any pressure (except for that, negligible, due to its own weight), and has an exposed portion 161 extending beyond the stroke chamber 155 (in the opened top end of the activation device 145); in such configuration, the movable body 135, being stressed by the spring 143, abuts against the gasket 140, so that no fluid communication between the inside of the bottle 125 and the inside of the carbonator 105 through the gas supply pipe 115 and the hollow chamber 150 is established. In an active configuration (determining the opening of the valve 130), the actuator 160, as a result of an exerted pressure (as will be described below) on said exposed portion 161, slides through the hollow chamber 150 and the stroke chamber 155 until pushing on the movable body 135, which is thus pushed down thereby enabling the passage of carbon dioxide to the gas supply pipe 115 (and thus to the carbonator 105) through the grooves and the hollow chamber 150; such passage of carbon dioxide to the carbonator 105 is facilitated and assisted by the Venturi effect, which prevents part of the gas coming out from the valve 130 from being released through the top opening of the activation device 145 by passing through the stroke chamber 155. The amount of sliding allowed by the actuator 160 along the hollow chamber 150 and the stroke chamber 155 during the closing and opening of the valve 130 is limited by an end stroke element 163 mounted on the actuator 160 (or integral part thereof); such end stroke element 163 consists of an enlarged cross-section portion (with respect to the body of the actuator 160) extending perpendicularly to the axis of the actuator 160 for a width greater than the width of the stroke chamber 155; in this way, by beating against a shoulder defined by the wall of the hollow chamber 150 at the intake of the stroke chamber 155 (upper end stroke) or against the gasket 140 (lower end stroke), the end stroke element 163 limits the extent of the sliding of the actuator 160, thus preventing that an excessive pressure of residual carbon dioxide within the hollow chamber 155 (or coming from the gas supply pipe 115) pulls out the actuator 160 from the stroke chamber 155 (in the closing condition of the valve 130) or that the actuator 160 exerts an excessive stress on the movable body 135 (in the opening condition of the valve).

The pressure on the actuator 160 that causes the descent thereof (and thus the action of the latter on the movable body 135) is exerted by a contact portion 165 fitted at a substantially central region of a rod 170.

One end a of the rod 170 is hinged to a support 175 secured to (or integral part of) the external body of the activation device 145, whereas the other end b is subjected to a pushing action exerted by a cam 180 anchored to a shaft 185, which can be operated in rotation by a motor 190; in this way, the rod 170 can be operated in rotation with respect to the hinged end thereof.

The contact portion 165 (and thus the rod 170) is connected to the external body of the activation device 145 through a thrust spring 195, which, in rest condition (i.e., in the absence of pressure on the end b of the rod 170) keeps the rod 170 in equilibrium position. In such situation, the actuator 160, being subject only to the gravitational force that leads it to rest on the movable body 135 (but without biasing it), extends with its own exposed portion 161 above and beyond the stroke channel 155.

When the motor 190 is turned on, the shaft 185 is activated in rotation, and such rotation is transmitted to the cam 180; the end b of the rod 170 is pressed down by the cam 180, thus rotating about the hinged end a by a certain angle, and determining the compression of the spring 195, until the contact portion 165 begins pressing on the exposed portion 161 of the actuator 160; substantially, the mechanism that acts on the actuator 160 is a cam-cam follower assembly. The actuator 160, in turn, by sliding vertically within the stroke chamber 155 and the hollow chamber 150, biases the movable body 135, until the end stroke element 163, abutting the gasket 140, decrees the complete opening of the valve; in such situation, the inside of the bottle 125 is in fluid communication with the hollow chamber 150 through the grooves of the movable body 135 and therefore there is outflow of carbon dioxide into the carbonator 105. Naturally, in order to effectively maintain such configuration , it is necessary that the activation of the motor 190, and hence of the cam 180, is such as to have a stop at the maximum thrust exerted by the rod 170 on the actuator 160 (that is, such to have a controlled and correct biasing of the movable body 135). This can be achieved, for example, by using a motor of the stepper type, which, if powered, only stops in a well precise angular position, or a motor having rotation angle controlled by an encoder.

When the cam 180 further rotates and hence the rod 170, assisted by the return of the spring 195 (due to the decompression thereof), returns to the equilibrium position, thereby releasing the pressure on the actuator 160 (and hence the stress on the movable body 135), further outflow of carbon dioxide is prevented.

The motor 190 is controlled by a suitable electronic control unit 197, which is configured for acquiring and processing an electric signal indicative of a pressure value within the carbonator 105, and providing a corresponding command signal to the motor 190, in order to adjust the start, stop and speed thereof according to the difference between the pressure value within the carbonator 105 and the desired one.

The detection of the pressure within the carbonator 105 is assigned to a pressure sensor 199 of a known type, which, mounted on the carbonator 105 (for example on the top wall, as shown in the figure), detects the pressure exerted by the gas thereon and transduces it into the corresponding electric signal that will be then sent to the electronic control unit 197 for the generation of the respective command signal that controls the motor 190.

The carbonation of the desired beverage, for example water, may be made through various successive carbonation cycles, at the end of each one of which the carbonated water is taken, in whole or in part as needed, and new primary water can therefore be introduced into the carbonator 105 to be carbonated.

In particular, at the beginning of a new cycle, the primary water is injected into the carbonator 105, wherein, by mixing with carbonated water and with undissolved carbon dioxide possibly remaining from the previous carbonation cycle, forms secondary water (i.e., water only partially carbonated with respect to the desired level of carbonation).

In such condition, the undissolved carbon dioxide within the carbonator 105 has necessarily a pressure value lower than the predefined value (assuming that it is desired to have the same pressure value as in the previous cycle) that is such as to ensure the desired carbonation level thereof. Therefore, the pressure sensor 199 detects such pressure, transduces it into the corresponding electric signal, and sends the latter to the electronic control unit 197; being such pressure value lower than the predefined pressure value, the electronic control unit 197 generates an appropriate driving electric signal that activates the motor 190.

The motor activation causes, as previously described in detail, the opening of the valve 130, thereby allowing the carbon dioxide contained within the bottle 125 to outflow therefrom, and be directed into the carbonator 105 (by passing through the hollow chamber 150 and the supply pipe 115), wherein it mixes to the secondary water contained therein.

As soon as the undissolved carbon dioxide exerts on the pressure detector 199 a pressure substantially equal to the predefined pressure value, the electronic control unit 197 receives the electrical signal indicative of this condition and in turn produces the driving signal for controlling the motor stop, thereby causing the closing of the valve 130.

After the carbonated water has been obtained, it can be taken through the delivery pipe 120, and a new cycle equivalent to the previous one may begin. The apparatus 100 described above can be used both in large-scale industrial plants, and on a small scale for the household carbonators; for example, the carbonation apparatus may be effectively and easily integrated in refrigeration appliances, such as a refrigerator 200 shown in a very schematic way in FIG. 2. The refrigerator 200 substantially includes an inner compartment (not visible in the figure) for food storage, and one or more (two, in the example herein illustrated) doors 205a, 205b for accessing such inner compartment. The refrigerator 200 also includes a beverage dispensing device of a known type, denoted by the reference 210 in the figure, for allowing the user help him(her)self with beverages without having to access the inner compartment of the refrigerator; the described carbonation apparatus 100 may be easily coupled with such delivery device 210, for example by integrating it within the access door 205a, as exemplarily shown in the figure (naturally, the relative position of the carbonation apparatus 100 and of the delivery device 210 is not limitative for the present invention and substantially depends on design requirements relating to technical and/or aesthetic aspects). In this way, the refrigerator 200 may dispense carbonated beverage by exploiting the combined action of the (known) beverage dispensing device 210 and of the carbonation apparatus 100 object of the present invention.

The present invention is advantageous since the carbonation level that can be obtained is now chosen on the basis of settings of easily accessible parameters of the pressure sensor. The system is hence simple and versatile, as well as reliable. Avoiding the use of a pressure mechanical reducer, in fact, makes it possible to form the components in plastic materials instead of metals, with consequent advantage in terms of ease of manufacturing, and therefore low costs. The described system, moreover, thanks to the use of the motor that controls the actuator, ensures that the opening and closing conditions of the valve are precise, controlled and remain stable over time even after having performed several carbonation cycles.

Finally, the water may now be injected with minimal pressure into the carbonator, thus ensuring to obtain a high variety of carbonation levels of carbonated water.

Naturally, in order to satisfy local and specific requirements, a person skilled in the art may apply to the solution described above many logical and/or physical modifications and alterations. In particular, although the present invention has been described with a certain degree of detail with reference to preferred embodiments thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a matter of general design choice.

For example, the described system may be used for mixing any type of fluid, without departing from the protection scope of the present invention. In particular, the carbonation system is a particular type of mixing apparatus, and therefore it may be used for creating gas-gas, liquid-gas, or liquid-liquid combined solutions, with no distinction for the type or kind for the used liquid or gas.

The bottle, in general, may be any storage container adapted to contain liquids and/or gasses; therefore, the valve may also be not provided, or it may be replaced by an equivalent element.

Moreover, the opening and closing configurations of the valve should not be construed in a limitative way; for example, it is easily possible to provide that the motor causes the actuator having more operating configurations; in particular, the regulation of the sliding of the actuator can be fine, so as to stress even only partially the movable body in order to adjust the amount of gas that is allowed to pass into the carbonator; in this way it can be avoided that an excessive gas flow lets the predefined pressure value at which the pressure detector signals to turn off the motor exceed.

The type of motor is not per se limiting for the present invention. In particular, the type of motor may be chosen based on design and/or economic considerations. For example, it is possible to use motors of the brushless or stepper type, according to the performance to be obtained; the latter have, for example, low costs and good performance, as well as high mechanical and electrical strength. Significant parameters that may guide the choice on a particular type of motor are the possibility to have very low rotation speed (even without the use of mechanical reducers) the stability in the position (absence of oscillations) at blocked rotor, and simple (or absent) initial calibration. Finally, the motor and the cam, or even all the motor-cam-cam follower assembly may be replaced by an equivalent component, such as an electro-mechanical device activated by a solenoid.

The cam-cam follower thrust system is not per se necessarily limiting for the present invention; various mechanical solutions, also known in the art, may be used for improving the mechanical efficiency without, however, jeopardizing the idea at the basis of the present invention.

Even the pressure sensor is not limiting for the present invention; for example, it is possible to use (relative or differential) electronic pressure switches, also programmable, piezoresistive-bridge pressure gauges, according to the carbonation specifications that are expected to use and precision that it is desired to achieve. The pressure sensor may also be combined with electronic processing circuitry, such as a pre-amplifier in order to increase the level of signal to noise ratio and thus make the pressure control and the motor driving more precise.

In the simplest cases, the electronic controller may also be not present. Additionally or alternatively, the electronic controller may be replaced by a digital controller implemented, for example, partially or entirely by software, which receives the pressure value from the pressure sensor through proper acquisition boards. This can be achieved at relatively low costs since no particularly high acquisition and processing speeds are required.

The described system may be designed for domestic or industrial applications; for example, such system can be integrated in refrigerators or associated with known tap water filtering devices.

1. A refrigerator (200) comprising a fluid mixing apparatus (100) for adding a gas, contained in a storage bottle (125) provided with a valve device (130), to a liquid within a mixing chamber (105), the mixing between the gas and the liquid within the mixing chamber forming a composite solution of mixed gas and liquid and gas being not mixed with the liquid, wherein the pressure value of said unmixed gas is indicative of the amount of mixed gas within the composite solution,
characterized by comprising a pressure detector (199) configured to detect the pressure value of the unmixed gas within the mixing chamber, and
control means (145, 165, 170, 175, 180, 185, 190, 195, 197) for controlling, as a function of the detected pressure value, the opening or closing of said valve device in order to automatically adjust the gas flow from the storage bottle to the mixing chamber.

2. The refrigerator according to claim 1, wherein the pressure detector is operable for transducing the detected pressure value into a corresponding electric signal supplied to said control means, and said control means are operable for processing said electric signal and, depending on the results of the processing, for controlling the valve device to adjust the gas flow from the storage bottle to the mixing chamber.

3. The refrigerator according to claim 2, wherein the control means includes:
an activation device (145) of the valve device mountable on said valve device;
an actuation assembly (165, 170, 175, 180, 185, 195, 190, 197) adapted to actuate said activation device on the basis of the electric signal provided by the pressure detector.

4. The refrigerator according to claim 3, wherein the activation device includes a movable actuator element (160) adapted to exert or release a push on a movable member (135) of the valve device so as to allow the opening or closing of the valve device, respectively.

5. The refrigerator according to claim 4, wherein the actuation assembly comprises motor means (165, 170, 175, 180, 185, 190, 195) operatively coupled with the movable actuator element and activatable for moving the same.

6. The refrigerator according to claim 5, wherein the actuation assembly includes a cam actuator device (165, 170, 175, 180, 185, 195), said cam actuator device being configured for moving the movable actuator element.

7. The refrigerator according to claim 5, wherein the actuation assembly includes a solenoid operatively coupled with the movable actuator element and activatable for moving the same.

8. The refrigerator according to any claim from 5, wherein the actuation assembly includes:
an electronic controller (197) adapted to receive the electric signal indicative of the pressure of the unmixed gas within the mixing chamber and to provide a corresponding control signal to the motor means for controlling the start or the stop thereof, depending on said pressure within the mixing chamber is lower than or equal to a predefined pressure value, respectively.

9. A fluid mixing apparatus (100) for adding a gas, contained in a storage bottle (125) provided with a valve device (130), to a liquid within a mixing chamber (105), the mixing between the gas and the liquid within the mixing chamber forming a composite solution of mixed gas and liquid and gas being not mixed with the liquid, wherein the pressure value of said non-mixed gas is indicative of the amount of mixed gas within the composite solution,
characterized by comprising
a pressure detector (199) configured to detect the pressure value of the non-mixed gas within the mixing chamber, and control means (145, 165, 170, 175, 180, 185, 190, 195, 197) for controlling, as a function of the detected pressure value, the opening or closing of said valve device in order to automatically adjust the gas flow from the storage bottle to the mixing chamber.
